(19) United States
(12) Patent Application Publication
(10) Pub. No.: US 2008/0285535 A1
(43) Pub. Date: Nov. 20, 2008

(54) Multi-Fa Processing System and Its Digital Band-Pass Filtering Method

(75) Inventors: Bong-Guk Yu, Daejeon (KR); Young-Jo Bang, Daejeon (KR); Jin-Up Kim, Daejeon (KR)

Correspondence Address: CANTOR COLBURN, LLP, 20 Church Street, 22nd Floor, Hartford, CT, 06103, US

(73) Assignee: Electronics and Telecommunications Research Instit, Daejeon (KR)

(21) Appl. No.: 12/096,465

(22) PCT Filed: Dec. 5, 2006
(86) PCT No.: PCT/KR06/05201

§ 371 Date: Jun. 6, 2008

(30) Foreign Application Priority Data
Dec. 8, 2005 (KR) 10-2005-0119911
Jun. 7, 2006 (KR) 10-2006-0050720

(51) Int. Cl. H04J 1/00

(52) U.S. Cl. 370/343

(57) ABSTRACT

A multi-channel processing system for selectively generating and transmitting/receiving a desired channel (FA: Frequency Assignment) signal and a band-pass filtering method thereof are provided. The multi-channel processing system includes a controller for receiving a channel selection signal including ON/OFF information of the respective channels and generating a filter coefficient corresponding to the channel selection signal; an input signal generator for generating an input signal; and a band-pass filter for changing a predetermined filter coefficient according to the filter coefficient generated by the controller and filtering the input signal from the input signal generator. Accordingly, since the controller can change the filter coefficient of the band-pass filter and selectively generate a channel, an efficient and simple multi-channel processing system using one band-pass filter regardless of the number of generated channels may be provided.

### TECHNICAL FIELD

The present invention relates to a multi-channel processing system. More particularly, the present invention relates to a multi-channel processing system for selecting a desired frequency assignment (hereinafter referred to as “FA”) channel signal and outputting and transmitting/receiving the same, and a digital band-pass filtering method thereof.

### BACKGROUND ART

Code division multiple access (CDMA) that is widely used in a wireless communication system is representative of a multi-channel system. A commercially available second generation digital mobile telephone system, that is, the Interim Standard (IS)-95 CDMA system, has a frequency bandwidth of 1.23 MHz or 1.25 MHz for the each channel (FA), and a third generation mobile communication system, that is, the IMT-2000-based non-synchronized WCDMA system, has a 5 MHz frequency bandwidth for one channel (FA). Since a mobile communication provider configuring a mobile communication network with a CDMA system generally uses a plurality of FAs, equipment such as a signal generator or a relay unit using the CDMA scheme must generate or relay a plurality of FAs.

Such a multi-channel system necessarily requires a filtering operation using a filter so as to pass only a desired band of signals and to not pass a non-desired band of signals. The filter is generally classified according to passed frequency bandwidth and system stability. To classify the filters according to a passed frequency bandwidth, the filter includes a high-pass filter (HPF) for passing high frequency signals, a low-pass filter (LPF) for passing low frequency signals, and a band-pass filter (BPF) for passing a predetermined frequency bandwidth. To classify the same according to system stability, it includes a finite impulse response (hereinafter referred to as FIR) filter and an infinite impulse response (hereinafter referred to as IIR) filter. The FIR filter has a fairly complicated structure, but has stable operation in that a phase response characteristic is linear. The IIR filter has a simple structure, but has unstable operation in that a phase response characteristic is non-linear.

The multi-FA processing system is a equipment for selectively generating, transmitting, and receiving a desired channel signal among a plurality of channels using an appropriate filtering method that satisfies the system requirements among the filters.

The related art of the conventional multi-FA processing system includes Patent Application Number 2000-0023467 entitled “A code division multiple access channel signal generator” (2000 May 2), Patent Application Number 2001-0058311 entitled “A transmission power measuring apparatus of a mobile communication base station” (2001 Sep. 20), and Patent Application Number 2003-0018548 entitled “CDMA backward link signal selection apparatus” (2003 Mar. 25).

In the conventional multi-channel processing system, the number of band-pass filters for processing a channel signal is equal to the number of channels that the band-pass filter processes. That is, so as to process M channels, the same M number of band-pass filters are provided. Further, the conventional multi-channel processing system has a drawback in increasing system-realization space and cost as the number of processed channels is increased. In addition, it is impossible for the plurality of channels to be selected by one band-pass filter at one time and to be generated simultaneously. Accordingly, it is difficult and non-economical to realize a system because a plurality of band-pass filters are used to select and generate the plurality of channels.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a multi-channel processing system and a band-pass filtering method thereof having advantages of changing a filter coefficient of one band-pass filter and selectively generating a channel to thereby provide an efficient, simple, and inexpensive multi-channel processing system.

### Technical Solution

An exemplary embodiment of the present invention provides a multi-channel processing system for selectively generating and transmitting/receiving a desired channel (FA: Frequency Assignment) signal. The multi-channel processing system includes a controller for receiving a channel selection signal including ON/OFF information of the respective channels and generating a filter coefficient corresponding to the channel selection signal; an input signal generator for generating an input signal; and a band-pass filter for changing a predetermined filter coefficient according to the filter coefficient generated by the controller and filtering the input signal from the input signal generator.

Another embodiment of the present invention provides a band-pass filtering method of a multi-channel processing system for selectively generating and transmitting/receiving a desired channel (FA: Frequency Assignment) signal. The band-pass filtering method includes a) receiving a channel selection signal including ON/OFF information of the respective channels and generating a filter coefficient corresponding to the channel selection signal; (b) changing a predetermined filter coefficient according to the generated filter coefficient; and (c) outputting a filtered input signal using the changed filter coefficient.

### DESCRIPTION OF DRAWINGS

FIG. 1 is a block diagram showing a general multi-channel processing system.

FIG. 2 is a block diagram showing a general FIR band-pass filter.

FIG. 3 is a block diagram showing a multi-channel processing system according to an exemplary embodiment of the present invention.

FIG. 4 is a flowchart showing a band-pass filtering method of a multi-channel processing system according to an exemplary embodiment of the present invention.

FIG. 5 is a flowchart showing how to generate a filter coefficient in a controller of a multi-channel processing system according to an exemplary embodiment of the present invention.

FIG. 6 illustrates an output of a channel signal that is filtered by a multi-channel processing system according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

When it is described that an element is coupled to another element, the element may be directly coupled to the other element or coupled to the other element through a third element.

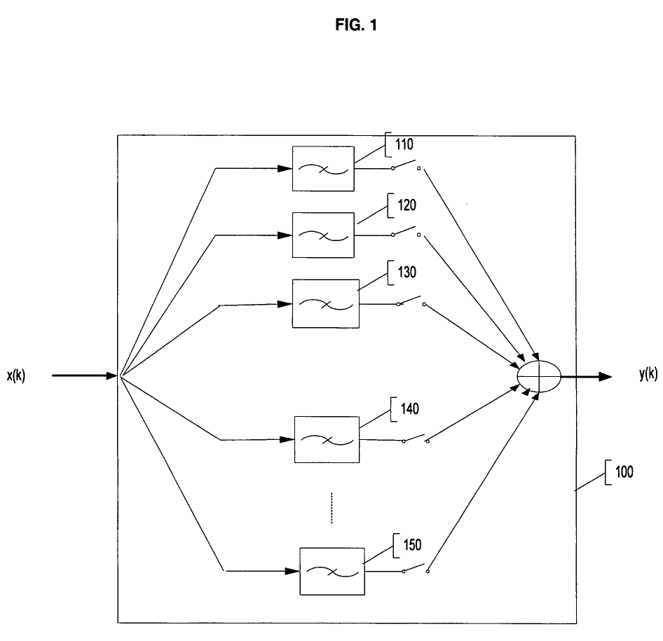

FIG. 1 is a block diagram showing a general multi-channel processing system.

As shown in FIG. 1, the general multi-channel processing system 100 includes M numbered band-pass filters (BPF) such as a first band-pass filter 110, a second band-pass filter 120, a third band-pass filter 130, a fourth band-pass filter 140, . . . , and an M-th band-pass filter 150, and an output signal y(k) is a sum of signals output by filtering an input signal x(k) by the first to M-th band-pass filters 110, 120, 130, 140, and 150), and may be given as follows.

y(k)=y₁(k)+y₂(k)+y₃(k) . . . +y_{M}(k) k=0, 1, 2, . . . (Equation 1)

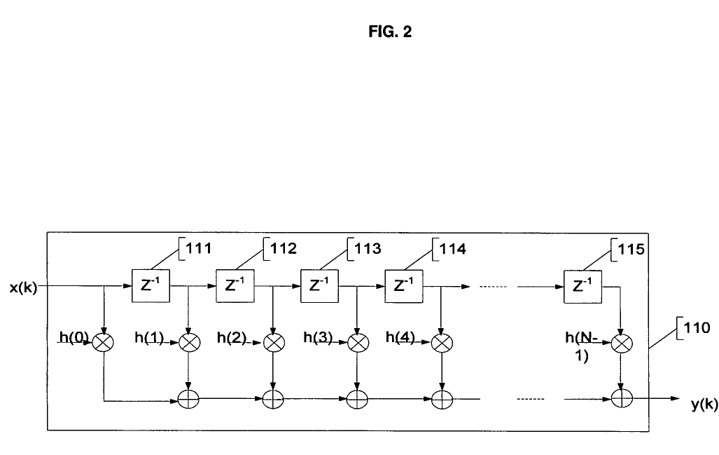

In order to explain each filter coefficient of the first to M-th band-pass filters 110, 120, 130, 140, and 150 from Equation 1, FIG. 2 is referred to.

FIG. 2 is a block diagram showing a general FIR band-pass filter. As shown in FIG. 2, when the digital FIR band-pass filter 110 has N-numbered filter taps, the digital FIR band-pass filter 110 includes a first delay element 111, a second delay element 112, a third delay element 113, a fourth delay element 114, . . . , (N−1)-th delay element 115. At this time, filter coefficients h(n) respectively applied to signals through the first to (N−1)-th delay elements 111, 112, 113, 114, and, 115 are given as h(0), h(1), h(2), h(3), h(4), . . . , h(N−1).

In a digital area, the output signal y(k) may be expressed by a convolution of the input signal x(k) and the filter coefficient h(n), and may be given as Equation 2.

$$y ( k ) = {\sum }_{n = 0}^{N - 1} h ( n ) x ( k - n ) \\ k = 0 , 1 , 2 , … \qquad ( Equation 2 )$$

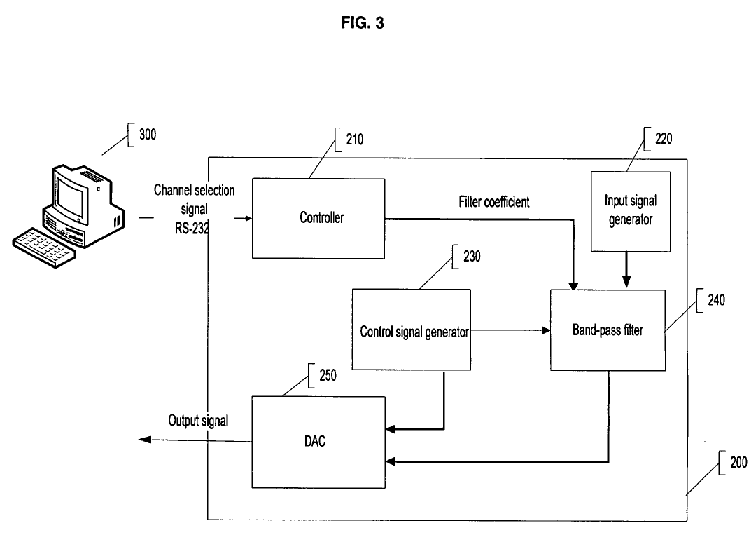

FIG. 3 is a block diagram showing a multi-channel processing system according to an exemplary embodiment of the present invention.

Referring to FIG. 3, a multi-channel generator 200 according to an exemplary embodiment of the present invention includes a controller 210, an input signal generator 220, a control signal generator 230, a band-pass filter 240, and a digital-to-analog converter (DAC) 250.

The controller 210 includes a micro controller, which stores the number of filter coefficients, the total number of channels (FA) of the system, a base-band filter coefficient, an spacing between the channels (FA), and a center frequency of a first channel and a sampling frequency, and it generates a filter coefficient using the data according to the application of the channel selection signal. The data may be received from a channel selection input unit 300, or may be programmed by the controller 210.

The channel selection input unit 300 is used for inputting a channel selection signal which is information regarding ON/OFF of the respective channels, and may include equipment such as a computer, a user terminal, and a keypad. The signal transmission between the channel selection input unit 300 and the controller 210 may be realized by an RS-232, that is, an input/output series interface as shown in FIG. 3.

The input signal generator 220 generates an input signal to be applied to the band-pass filter 240. The input signal generated from the input signal generator 220 may be changed according to usage of an exemplary embodiment of the present invention. For example, if the multi-channel processing system according to an exemplary embodiment of the present invention is used as a signal generator, the input signal may become a random signal or a PN sequence signal. Further, if the multi-channel processing system according to an exemplary embodiment of the present invention is used as CDMA relay system, the input may become a CDMA signal that is transmitted to the relay system.

The band-pass filter 240 is downloaded with a filter coefficient set in real-time, in which the filter coefficient is generated by the controller 210 through a interface with the controller 210. The band-pass filter 240 includes a field programmable gate array (FPGA) or a digital signal processor (DSP) chip.

The band-pass filter 240 is for filtering a desired channel. According to an exemplary embodiment of the present invention, the band-pass filter 240 uses a digital finite impulse response (FIR) band-pass filter (BPF). The digital FIR band-pass filter is advantageous in terms of symbol synchronization of the digital communication system because a delay of the frequency is not changed according to a linear phase response characteristic frequency, it is stable because it is not affected by the peripheral environment, and it can control a frequency response.

The band-pass filter 240 changes the stored filter coefficient according to the filter coefficient generated from the controller 210, and filters the input signal applied from the input signal generator 220 by the changed filter coefficient.

The digital-to-analog converter (DAC) 250 converts the digital signal that is output and filtered by the band-pass filter 240 into an analog signal.

The control signal generator 230 provides a control signal and an operation clock signal for the digital filtering of the band-pass filter 240 in real-time, and controls an internal register configuration for driving the digital-to-analog converter 250.

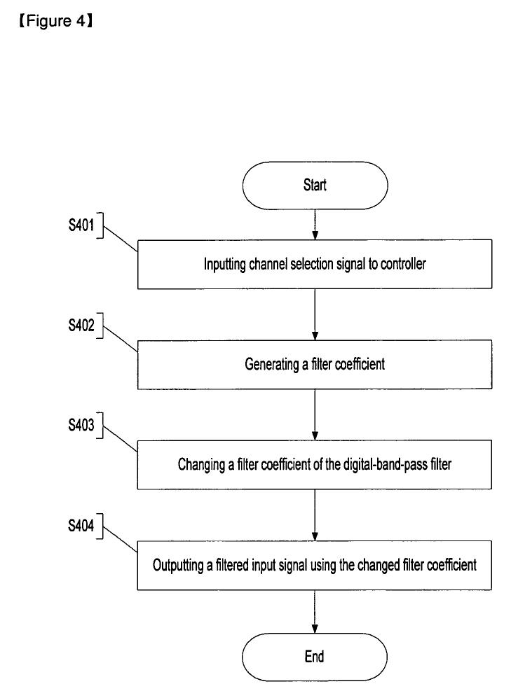

FIG. 4 is a flowchart showing a band-pass filtering method of a multi-channel processing system according to an exemplary embodiment of the present invention.

First, the channel selection signal is input into the channel selection input unit 300 (see FIG. 3) and then applied to the controller 210 (S401), and the controller 210 generates a filter coefficient corresponding to the channel selection signal (S402). The filter coefficient of the band-pass filter 240 is changed according to the application of the filter coefficient generated by the controller 210 (FIG. 3) (S403), and the band-pass filter 240 filters the input signal applied from the input signal generator 220 using the changed filter coefficient and outputs the filtered signal (S404).

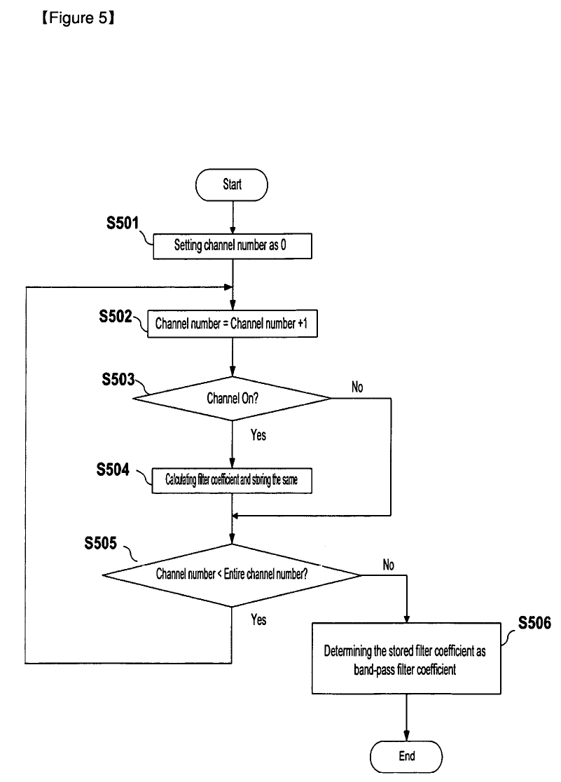

FIG. 5 is a flowchart showing generation of a filter coefficient in a controller of a multi-channel processing system according to an exemplary embodiment of the present invention.

Referring to FIG. 5, the controller 210 establishes a channel number as “0” in response to the input of the channel selection signal to the channel selection input unit 300 (S501), and increases the channel number by “1” (S502). The controller 210 determines whether the channel corresponding to the channel number is in an ON state with reference to the input channel selection signal (S503). If the channel is determined as in the ON state, the controller calculates a filter coefficient and stores the calculated filter coefficient (S504). The controller 210 then compares the channel number to the predetermined total number of channel (S505), and if the channel number is less than the total number of channel, the steps after step S502 are repeated. If the corresponding channel is in an OFF state at the step S503, the controller 210 does not calculate the filter coefficient and runs the step S505.

Equation 5 described hereinafter is referred to so as to explain the calculation of the step S504. First, in order to introduce Equation 5 as applied to an exemplary embodiment of the present invention, Equation 1 is generalized as follows.

$$\begin{matrix}y ( k ) = {y}_{1} ( k ) + {y}_{2} ( k ) + {y}_{3} ( k ) … + {y}_{M} ( k ) \\ k = 0 , 1 , 2 , … \\ = {\sum }_{n = 0}^{N - 1} {h}_{1} ( n ) x ( k - n ) + {\sum }_{n = 0}^{N - 1} {h}_{2} ( n ) x ( k - n ) + … + \\ {\sum }_{n = 0}^{N - 1} {h}_{M} ( n ) x ( k - n ) \\ = {\sum }_{n = 0}^{N - 1} \{ {h}_{1} ( n ) + {h}_{2} ( n ) + {h}_{3} ( n ) + … {h}_{M} ( n ) \} x ( k - n ) \\ = {\sum }_{n = 0}^{N - 1} {h}_{all} ( n ) x ( k - n )\end{matrix} \qquad ( Equation 3 )$$

Equation 3 is used for a mathematical background of the digital band-pass filtering method according to the exemplary embodiment of the present invention. In the general multi-channel processing system as shown in FIG. 1, the controller according to an exemplary embodiment of the present invention 210 may generate the same filter coefficient hall(n) as the sum of h1(n), h2(n), h3(n), h4(n), . . . , hM(n), which is each filter coefficient of the M digital band-pass filters.

As shown in FIG. 1, in the general multi-channel system, the necessary number of band-pass filters is equal to the channel number and the filter coefficients of each band-pass filter are different, and accordingly, the same number of filter coefficients as the number of channels is used. Herein, when the total channel number is given as M and the sampling frequency is given as fs, the filter coefficient hj(n) of each channel may be expressed as Equation 4.

hⱼ(n)=h_{B}(n)·fⱼ(n)=h_{B}(n)·cos(2πfⱼn/fₛ) j=1, 2, . . . , M (Equation 4)

In Equation 4, hB(n) is given as a base-band filter coefficient, and fj(n) is given as a carrier signal having a center frequency of each channel.

The controller 210 generates the filter coefficient hall(n) by accumulating Equation 4 concerning the filter coefficients of each channel according to characteristics of an exemplary embodiment of the present invention using one band-pass filter, and the filter coefficient hall(n) may be expressed as Equation 5.

$$\begin{matrix}{h}_{all} ( n ) = {\sum }_{j = 1}^{M} {w}_{j} {h}_{j} ( n ) & n = 0 , 1 , 2 , … , N - 1 \\ & {w}_{j} = 0 , if FA \# j = \text{‘‘} OFF \text{’} \text{’} \\ & 1 , if FA \# j = \text{‘} \text{‘} ON \text{’} \text{’}\end{matrix} \qquad ( Equation 5 )$$

In Equation 5, N is given as a tap number of the filter, that is, the number of the filter coefficient, FA#j is given as a serial number increased from 1 to M when the entire channel number is given as M, and Wj is a variable that is changed according to the ON/OFF state of the FA.

Referring to Equation 5, the filter coefficient calculation formula of step S504 of FIG. 5 is given as follows.

Freq=channel number(FA#j)*channel_spacing+center frequency of first channel(f_start)

I signal: coeff [i]+=base-band filter coefficient(filter_coeff [i])*sin(2π*i*freq/sampling frequency(f_{—}samp))

*59 Q signal: coef [i]+=base-band filter coefficient(filter_coeff [i])*con(2πr*i*freq/sampling frequency(f_{—}samp)) (Equation 6)

Here, i=0, 1, 2, . . . , N−1.

Equation 6 express Equation 4 as I signal and Q signal, which are orthogonal modulation values. In Equation 6, freq means a center frequency of the each channel given according to the serial number of the channel, and I signal and Q signal respectively mean In-phase signal and quadrature-phase signal. coeff [i]+ is given as a value obtained by accumulating a presently calculated value to a coeff [i] value as a calculated sum of the previous channel. Referring to FIG. 5, coeff [i]+ determines a band-pass filter coefficient by accumulating the filter coefficients until the channel number is equal to the total channel number.

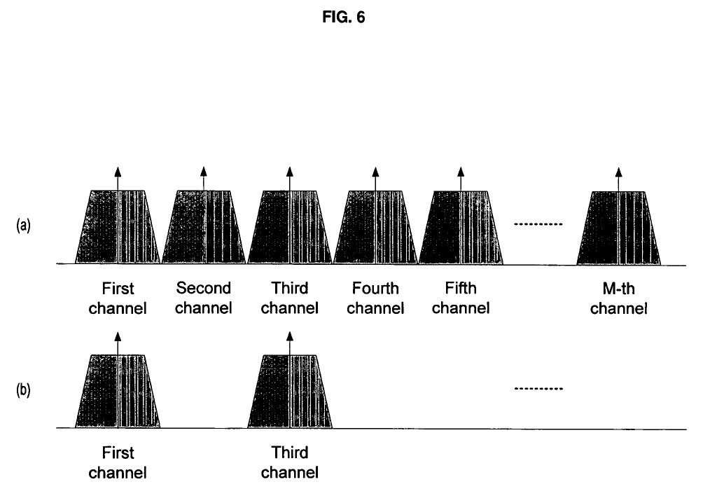

FIG. 6 respectively illustrate an output of a channel signal filtered by a multi-channel processing system according to an exemplary embodiment of the present invention.

As shown in (a) of FIG. 6, M output waveforms of the first channel, the second channel, the third channel, the fourth channel, the fifth channel, . . . , the M-th channel are output signals of the band-pass filter 240 when the band-pass filter 240 is operated according to the filter coefficient generated by the channel selection input unit 300 applying the channel selection signal for turning on all the M channels to the controller 210. Likewise, (b) of FIG. 6 illustrates output signals of the band-pass filter 240 when the band-pass filter 240 is operated according to the filter coefficient generated by the channel selection input unit 300 applying the channel selection signal for turning on the first and third channels to the controller 210.

The controller 210 generation of a filter coefficient is described with reference to the (b) of FIG. 6.

For convenience of explanation, the entire channel number M is assumed to be 8.

The controller 210 receives 1 byte signal “10100000” as the selection signal from the channel selection input unit 300 and stores each channel ON/OFF information such as the first channel=“ON”, the second channel=“OFF”, the third channel=“ON”, the fourth channel=“OFF”, the fifth channel=“OFF”, the sixth channel=“OFF”, the seventh channel=“OFF”, and the eighth channel=“OFF”. After the controller 210 stores each channel as ON or OFF, the controller 210 calculates a final filter coefficient by multiplying the center frequencies of each ON state channel to the predetermined base-band filter coefficient and summing the multiplied values.

The spacing between the channels and the center frequency of the first channel are previously established and stored at the controller 210. If the interval of the channels is given as 5 MHz and the center frequency of the first channel is given as 13 MHz, the center frequencies from the first channel to the eighth channel are respectively given as 13, 18, 23, 28, 33, 38, 43, and 48 MHz. The controller 210 generates a filter coefficient using the center frequency and the ON/OFF information of each channel such that the channel signals shown in FIG. 6 may be output.

As such, the multi-channel processing system according to an exemplary embodiment of the present invention controls filter coefficients of the band-pass filter by a controller so that it may simultaneously and selectively generate at least one channel by one band-pass filter. Thus, a simple and efficient multi-channel processing system may be provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The conventional multi-channel processing system has an increased area and cost as the channel capability for the band-pass filters to process is increased because the processed channel number is equal to the number of necessary band-pass filters. However, when the multi-channel processing system and band-pass filtering method thereof according to an exemplary embodiment of the present invention is used, the ON/OFF control of a plurality of channels can be performed by using one band-pass filter, and accordingly, a simple and economical multi-channel processing system may be realized. When the multi-channel processing system and band-pass filtering method thereof according to an exemplary embodiment of the present invention is used for the relay system, it may replace complicated and expensive RF components such as RF or IF SAW filters and RF switches.

### INDUSTRIAL APPLICABILITY

In addition, since the output channel number and filter coefficient may be changed in real-time by changing the channel selection signal input through the channel selection input unit, a expensive signal generators used in RF performance measurements of 2G or 3G CDMA systems may be replaced by one multi-channel signal generator.

1. A multi-channel processing system for selectively generating and transmitting/receiving a desired frequency assignment ((FA) signal, the multi-channel processing system comprising:
a controller for receiving a channel selection signal including ON/OFF information of the respective channels, and generating a filter coefficient corresponding to the channel selection signal;
an input signal generator for generating an input signal; and
a band-pass filter for changing a predetermined filter coefficient according to the filter coefficient generated by the controller and filtering the input signal input from the input signal generator.

2. The multi-channel processing system of claim 1, wherein the controller stores data including the number of filter coefficients, the total number of FAs, a base-band filter coefficient, an FA spacing, and a center frequency of a first channel and a sampling frequency.

3. The multi-channel processing system of claim 2, wherein the controller generates a filter coefficient corresponding to the channel selection signal.

4. The multi-channel processing system of claim 1, further comprising a digital-to-analog converter (DAC) for converting the input signal filtered by the band-pass filter into an analog signal and outputting the analog signal.

5. The multi-channel processing system of claim 4, further comprising a control signal generator for providing a filtering operation control signal and a clock signal to the band-pass filter and controlling an internal register setting so as to drive the digital-analog converter (DAC).

6. The multi-channel processing system of claim 1, wherein the band-pass filter is realized as a finite impulse response (FIR) band-pass filter.

7. A band-pass filtering method of a multi-channel processing system for selectively generating and transmitting/receiving a desired frequency assignment (FA) signal, the band-pass filtering method comprising:
(a) receiving a channel selection signal including ON/OFF information of respective channels and generating a filter coefficient corresponding to the channel selection signal;
(b) changing a predetermined filter coefficient according to the generated filter coefficient; and
(c) outputting an input signal that is filtered using the changed filter coefficient.

8. The band-pass filtering method of claim 7, wherein the step (b) of changing a predetermined filter coefficient includes:
(b1) setting a channel number as “0”;
(b2) increasing the channel number by “1” and storing the calculated filter coefficient of the channel number when the channel corresponding to the channel number is an ON state;
(b3) comparing the channel number to an total channel number and repeating the step (b2) of increasing the channel number and storing the calculated filter coefficient of the channel number when the channel number is smaller than the total channel number; and
(b4) changing a predetermined filter coefficient as the stored filter coefficient of the step (b2) when the channel number of the step (b3) is equal to or greater than the total channel number.

9. The band-pass filtering method of claim 8, wherein the step (b3) is performed without calculating a filter coefficient when the channel corresponding to the channel number is an OFF state at the step (b2).
